(19) United States
(12) Patent Application Publication
(10) Pub. No.: US 2012/0069361 A1
(43) Pub. Date: Mar. 22, 2012

(54) APPARATUS AND METHOD FOR DETECTION OF TONER CONSUMPTION

(75) Inventors: Joo Young JUNG, Suwon-si (KR); Ho Jin Ahn, Suwon-si (KR)

(73) Assignee: Samsung Electronics Co., Ltd, Suwon-si (KR)

(21) Appl. No.: 13/231,017

(22) Filed: Sep. 13, 2011

(30) Foreign Application Priority Data
Sep. 20, 2010 (KR) 10-2010-0092600

(51) Int. Cl. H04N 1/60

(52) U.S. Cl. 358/1.9

(57) ABSTRACT

An apparatus to detect toner consumption converts an original file into a spool file to perform preview before printing, converts the spool file into preview data, classifies objects based on types of items recorded in the spool file to create an object map, and calculates dot counts based on the preview data and information of the object map to detect toner consumption.

### CROSS-REFERENCE TO RELATED APPLICATIONS

This application claims the benefit of priority under 35 USC §119 from Korean Patent Application No. 10-2010-0092600, filed on Sep. 20, 2010 in the Korean Intellectual Property Office, the disclosure of which is incorporated herein by reference.

### BACKGROUND OF THE INVENTION

1. Field of the Invention

Embodiments of the present general inventive concept relate to an apparatus and method that detect toner consumption.

2. Description of the Related Art

Generally, an image forming apparatus forms a picture on a print paper using toner. As the picture is formed, an amount of the toner is gradually decreased. Toner consumption may be measured using various methods, such as a method using photo sensors and a method using a dot count.

In a method of measuring toner consumption using photo sensors, the photo sensors are mounted at opposite sides of a toner storage space to measure toner consumption. When the toner storage space is full of toner, light emitted from a light transmitting unit is intercepted. When the toner is exhausted, light emitted from the light transmitting unit is transmitted to a light receiving unit. In this method, toner consumption may not be indicated in stages but replacement timing of a developer including toner may be indicated. For this reason, a dot count calculation method, which indicates toner consumption in stages, is used.

In a method of calculating a dot count to measure toner consumption, the number of dots of picture data input to print media is calculated to measure toner consumption. As an example of calculating the number of dots of picture data, a document mainly used by a user, not an actual document to be output, is selected, and the estimated number of dots of picture data is calculated based on the selected document. In this method, however, there is a difference between actual toner consumption and estimated toner consumption.

### SUMMARY OF THE INVENTION

It is an aspect of the present general inventive concept to provide an apparatus and method that accurately measure toner consumption using preview data.

Additional aspects of the present general inventive concept will be set forth in part in the description which follows and, in part, will be obvious from the description, or may be learned by practice of the general inventive concept.

Features of the present general inventive concept may be realized by a detection apparatus of toner consumption includes an enhanced meta file (EMF) creation unit to convert an original file into an EMF so as to perform preview before printing, a preview data creation unit to convert the EMF into preview data, an object map creation unit to classify objects based on types of items recorded in the EMF to create an object map, and a dot count calculation unit to calculate dot counts of pixels based on RGB values of the preview data and object attributes so as to detect toner consumption.

The dot count calculation unit may calculate the dot counts of the pixels using an RGB/dot count lookup table showing relations between the RGB values of the preview data and the dot counts.

The object attributes may include a graph, a photo, and text, and the RGB/dot count lookup table may include a plurality of RGB/dot count lookup tables in which the dot counts correspond to the RGB values based on the object attributes.

The dot count calculation unit may calculate RGB values of the pixels of the preview data, detect object attributes of the pixels, the RGB values of which have been calculated based on the object map, and apply the RGB/dot count lookup tables prepared based on the object attributes of the pixels to the RGB values of the pixels to calculate dot counts of the pixels.

The dot count calculation unit may calculate dot counts of all pixels of the preview data and multiply the calculated dot counts by toner consumption per dot to calculate total toner consumption.

The object map creation unit may classify the objects as one selected from a group consisting of text, a photo, and a graph based on types of the items recorded in the EMF to create an object map.

Features of the present general inventive concept may also be realized by a detection method of toner consumption includes converting an original file into a spool file to perform preview before printing, converting the spool file into preview data, classifying objects based on types of items recorded in the spool file to create an object map, and calculating dot counts based on the preview data and information of the object map to detect toner consumption.

The spool file for preview may include an enhanced meta file (EMF) or a portable document format (PDF) file.

Converting the spool file into preview data may include converting the spool file into a picture file which is displayed on a screen during preview.

Classifying objects based on types of items recorded in the spool file to create an object map may include classifying the objects as one selected from a group consisting of text, a photo, and a graph based on types of the items recorded in the spool file to create an object map.

The detection method may further include calculating dot counts of the pixels using an RGB/dot count lookup table showing relations between the RGB values of the preview data and the dot counts.

Each of the objects may have an attribute of a graph, a photo, or text, and the RGB/dot count lookup table may include a plurality of RGB/dot count lookup tables in which the dot counts correspond to the RGB values based on the object attributes.

Calculating dot counts based on the preview data and information of the object map may include calculating RGB values of the pixels of the preview data, detecting object attributes of the pixels the RGB values of which have been calculated based on the object map, and applying the RGB/dot count lookup tables prepared based on the object attributes of the pixels to the RGB values of the pixels to calculate dot counts of the pixels.

The detection method may further include calculating dot counts of all pixels of the preview data and multiplying the calculated dot counts by toner consumption per dot to calculate total toner consumption.

Features of the present general inventive concept may also be realized by an apparatus to detect toner consumption of an image, the apparatus including a preview data creation unit to receive an enhanced meta file (EMF) corresponding to image data of an image to be printed and to generate preview data of the image, an object map creation unit to receive the EMF, to detect at least one type of object from among a plurality of types of objects in the image, and to generate an object map according to the detected at least one type of object, and a dot count calculation unit to receive the preview data and the object map, to determine a dot count of each object of the object map, and to generate dot count information of the preview image.

The apparatus may further include an EMF creation unit to receive an original image file and to generate the EMF.

The preview data creation unit may output the preview data as RGB data, and the dot count calculation unit may calculate the dot count information using an RGB/dot count lookup table.

The plurality of types of objects may include text, graphics, and photos, and the object map creation unit may generate the object map by classifying each object in the EMF into at least one of the plurality of types of objects.

The dot count calculation unit may generate the dot count information by providing different dot counts for each detected object type.

The dot count calculation unit may generate the dot count information by adding up the dot counts for each respective type of object in the preview image.

Features of the present general inventive concept may also be realized by an image forming system including an image forming apparatus to form an image on a printing medium by generating print dots on the printing medium, a display to display a preview image of the image, and a host device to receive image data, to generate preview image data to transmit to the display, to determine object types of each object detected in the preview image data, and to generate dot count information by associating each type of object with different dot counts.

The host device may include a preview data creation unit to receive an enhanced meta file (EMF) corresponding to the received image data, an object map creation unit to receive the EMF, to detect at least one type of object from among a plurality of types of objects in the image, and to generate an object map according to the detected at least one type of object, and a dot count calculation unit to receive the preview data and the object map, to determine a dot count of each object of the object map, and to generate dot count information of the preview image.

Features of the present general inventive concept may also be realized by a method of determining toner consumption, the method including classifying objects of an enhanced meta file (EMF) into a plurality of object types and applying different dot count data to each object type to generate dot count information of the EMF.

The method may include converting the EMF to RGB image data, and classifying the objects of the RGB image data into the plurality of object types.

The plurality of object types may include at least text, graphics, and photos.

Applying different dot count data includes applying separate lookup tables to each respective type of object to generate separate dot counts for each type of object.

The separate dot counts may correspond to print colors of a printing device, and the dot counts of each object corresponding to a respective color of the printing device may be added together to generate total dot counts for each respective color of the printing device.

Generating separate dot counts for each type of object may include adding up a number of pixels corresponding to each type of object, and multiplying the number of pixels corresponding to each type of object by a respective predetermined dot count value.

Classifying objects of the EMF may include detecting the object type corresponding to each pixel of the EMF.

The method may include generating a preview image based on the EMF.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a software block diagram of a detection apparatus of toner consumption according to an embodiment of the present general inventive concept;

FIG. 2A to 2C are schematic construction views illustrating a dot count calculation method of the detection apparatus of toner consumption according to an embodiment of the present general inventive concept;

FIG. 3 is a view illustrating a conventional dot count calculation process;

FIG. 4 is a view illustrating calculation of toner consumption using a one-bit half-toning result;

FIG. 5 is a view illustrating a dot count calculation process during color output of the detection apparatus of toner consumption according to an embodiment of the present general inventive concept;

FIG. 6 is a view illustrating a dot count calculation process during mono output of the detection apparatus of toner consumption according to an embodiment of the present general inventive concept;

FIG. 7 is a flow chart illustrating a toner consumption measuring method of the detection apparatus of toner consumption according to an embodiment of the present general inventive concept;

FIG. 8 is a diagram illustrating a structure of a detection apparatus according to an embodiment of the present general inventive concept; and

FIG. 9 illustrates a preview screen according to an embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to like elements throughout.

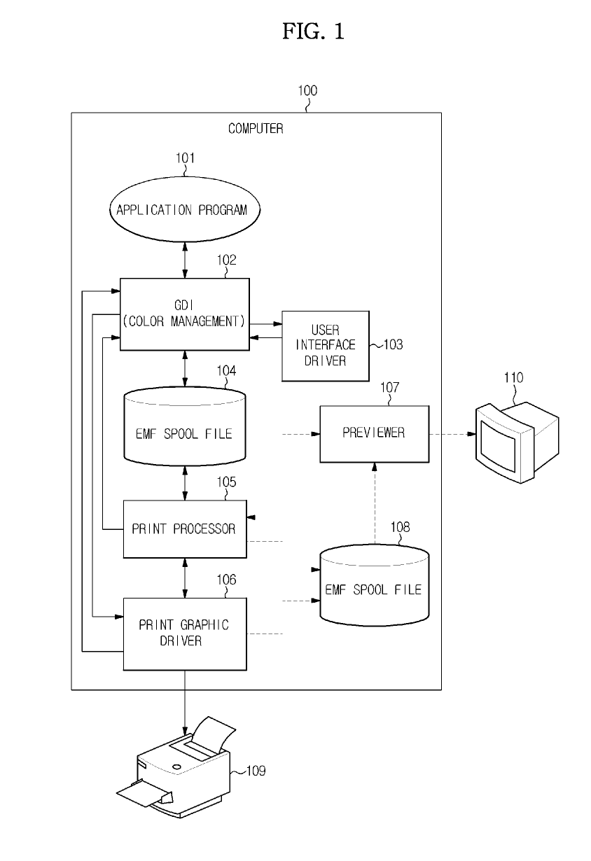

FIG. 1 is a software block diagram of a detection apparatus 100 of toner consumption according to an embodiment of the present general inventive concept. The detection apparatus 100 may be a host computer, for example.

The detection apparatus 100 of toner consumption includes an application program 101, a graphic device interface (GDI) 102, a user interface driver 103, enhanced meta file (EMF) spool files 104 and 108, a print processor 105, a printer graphic driver 106, and a previewer 107.

The detection apparatus 100 creates print data, which are transmitted to an image forming apparatus 109. The image forming apparatus 109 has a printing function. In this embodiment, a host computer having a print driver is used as an example of the detection apparatus 100, and a printer is used as an example of the image forming apparatus 109.

The application program 101 is provided in a memory, such as a hard disk drive, of the host computer 100. The application program 101 allows users to write documents. The application program 101 reads documents written by users or already prepared documents to print the documents. The application program 101 may be a word processor. Other examples of the application program may include a database program, a web browser, and a communication program. When the application program 101 prints a prepared document, the application program 101 sends a print request signal input through a user interface and the document to the GDI 102.

The GDI 102 draws a graphic object on a screen. The GDI 102 may be a component of MS Windows to perform graphic functions such as line drawing and color management. The GDI 102 may be a dynamic link library (DLL) providing a function that the application program uses to output graphs to a display, a printer, or other apparatuses and architecture related thereto. The GDI 102 may draw a straight line, a curved line, a polygon, text, and a bitmap image.

The GDI 102 temporarily spools data received from the application program 101 in the EMF spool file 104. Upon completion of spooling, the GDI 102 sends a print request to the print processor 105.

Upon reception of the print request from the GDI 102, the print processor 105 drives the previewer 107, a program to preview data. The print processor 105 requests the printer graphic driver 106 to create a file for preview through the GDI 102. The GDI 102 sends an inquiry about a color profile to the user interface driver (a UI function of a printer driver) 103. The GDI 102 performs color coincidence using the color profile based on identification (ID).

The GDI 102 loads a rendering command from the EMF spool file 104, applies a color coincidence process suitable for a display 110 to the rendering command, and sends an output request to the printer graphic driver 106. In response to the output request transmitted from the GDI 102, the printer graphic driver 106 sends an enhanced meta file (EMF) to the EMF spool file 108.

Upon reception of a spooling end message from the printer graphic driver 106, the print processor 105 requests the previewer 107 to perform preview. The previewer 107 loads an EMF, converts the EMF into bitmap data for preview, and displays the bitmap data.

Upon reception of a user's print command from the previewer 107, the print processor 107 instructs the printer graphic driver 106 to perform print processing of the EMF spool file 104 through the GDI 102. At this time, when a user designates color coincidence, the GDI 102 sends an inquiry about a color profile to the user interface driver 103. When the user interface driver 103 sends ID (identification) of a color profile for a printer, the GDI 102 performs color coincidence using the color profile having the sent ID.

The GDI 102 loads a rendering command from the EMF spool file 104, performs color coincidence suitable for the printer 109, and sends a print request to the printer graphic driver 106. The printer graphic driver 106 converts the print request into commands that the printer 108 interprets and sends the commands to the printer 109. The printer 109 prints data based on the commands.

In this embodiment, a dot count with respect to the preview document created as described above is calculated to measure toner consumption. The dot count may be calculated by the previewer 107, for example. Hereinafter, a dot count calculation method will be described.

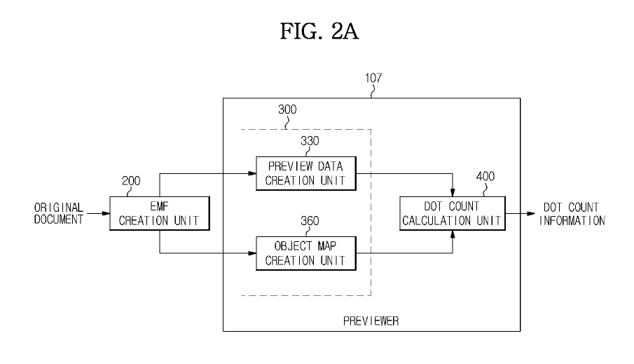

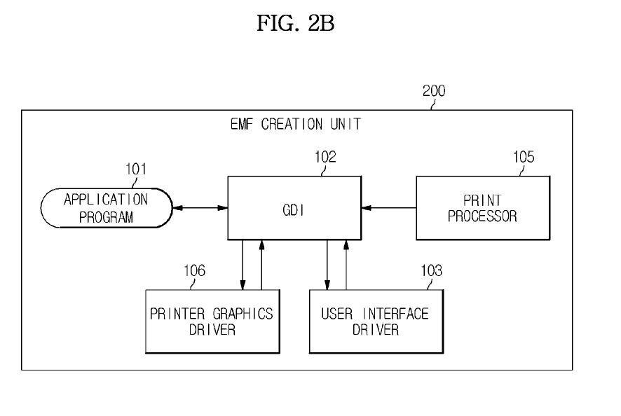

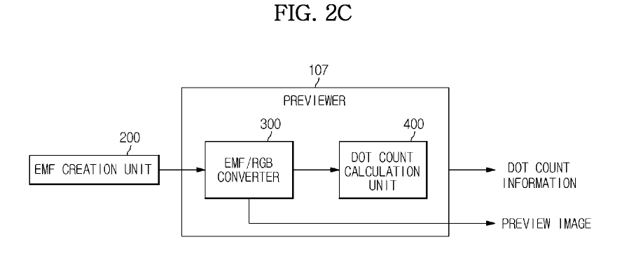

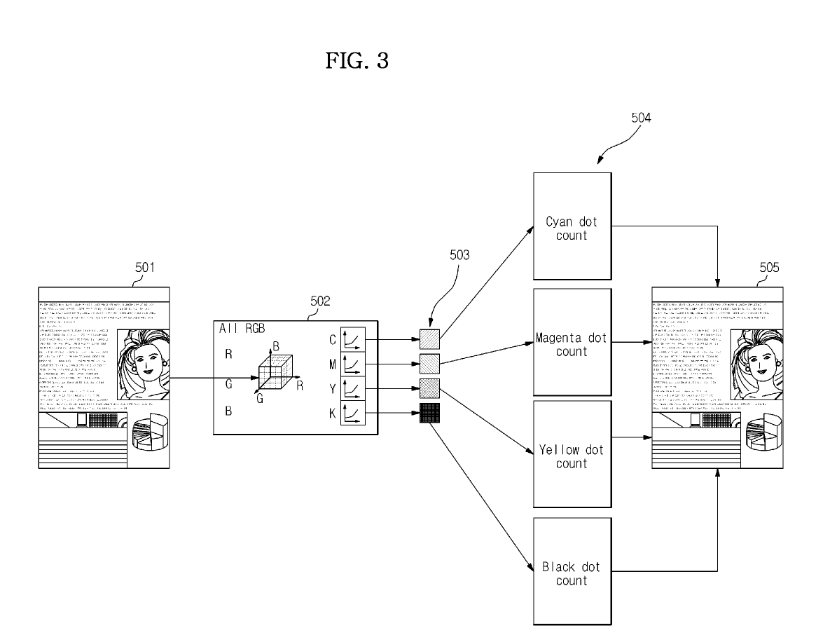

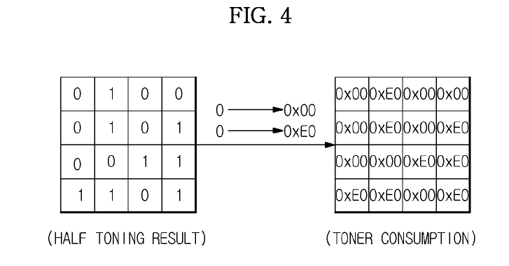

FIG. 2A is a schematic construction view illustrating a dot count calculation method of the detection apparatus of toner consumption according to an embodiment of the present general inventive concept, FIG. 3 is a view illustrating a conventional dot count calculation process, and FIG. 4 is a view illustrating calculation of toner consumption using a one-bit half-toning result.

The detection apparatus 100 of toner consumption includes an EMF creation unit 200 to convert an original file into an EMF based on spool data created according to a print command, a preview data creation unit 330 to convert the EMF into a picture file such as a bitmap (BMP), an object map creation unit 360 to record information showing object attributes, such as text, a graph, and a photo, for each position of the picture created at the EMF, and a dot count calculation unit 400 to calculate a dot count based on the picture file created by the preview data creation unit 330 and the object information created by the object map creation unit 360.

The EMF creation unit 200 includes all blocks of FIG. 1 to create the EMF stored in the EMF spool file 108 for preview. As illustrated in FIG. 2B, the EMF creation unit 200 may include the application program 101, the GDI 102, the print processor 105, the printer graphic driver 106, and the user interface driver 103. The preview data creation unit 330, the object map creation unit 360, and the dot count calculation unit 400 are modules belonging to the previewer 107. The preview data creation unit 330 and the object map creation unit 360 may be commonly referred to as an EMF/RGB converter 300.

The preview data creation unit 330 converts an EMF-format document into a picture file such as BMP. When the EMF-format document is converted into the BMP file, RGB values of each pixel are recognized.

The object map creation unit 360 records an object attribute of each pixel position of the EMF to create a map. For example, the object may include text, a graph, and a photo. Other attributes may be included in the object.

The object map creation unit 360 includes a type of each item recorded in the EMF. Objects may be classified into the following items.

### 1. Graphic Object

EMR_POLYBEZIER
EMR_POLYGON
EMR_POLYLINE
EMR_POLYBEZIERTO
EMR_POLYLINETO
EMR_POLYPOLYLINE
EMR_POLYPOLYGON
EMR_ANGLEARC
EMR_ELLIPSE
EMR_RECTANGLE
EMR_ROUNDRECT
EMR_ARC
EMR_CHORD
EMR_PIE
EMR_LINETO
EMR_ARCTO
EMR_POLYDRAW
EMR_BEGINPATH
EMR_ENDPATH
EMR_CLOSEFIGURE
EMR_FILLPATH
EMR_STROKEANDFILLPATH
EMR_STROKEPATH
EMR_FLATTENPATH
EMR_WIDENPATH
EMR_SELECTCLIPPATH
EMR_ABORTPATH
EMR_GDICOMMENT
EMR_FILLRGN
EMR_FRAMERGN
EMR_INVERTRGN
EMR_PAINTRGN
EMR_EXTSELECTCLIPRGN
EMR_POLYBEZIER16
EMR_POLYGON16
EMR_POLYLINE16
EMR_POLYBEZIERTO16
EMR_POLYLINETO16
EMR_POLYPOLYLINE16
EMR_POLYPOLYGON16
EMR_POLYDRAW16

### 2. Text Object

EMR_EXTTEXTOUTA
EMR_EXTTEXTOUTW
EMR_POLYTEXTOUTA
EMR_POLYTEXTOUTW

### 3. Photo Object

EMR_BITBLT
EMR_STRETCHBLT
EMR_MASKBLT
EMR_PLGBLT
EMR_STRETCHDIBITS
EMR_TRANSPARENTBLT

Items classified into the graphic, text, and photo objects are resource types constituting the EMF. EMR is an enhanced meta resource, and the EMF is configured in the form of EMR_i TYPE (tag type). The classification may be changed in other embodiments.

Upon classification of the objects based on each item type of the EMF, an object attribute of each pixel of the EMF is classified.

The dot count calculation unit 400 calculates a dot count based on the picture file created by the preview data creation unit 330 and the object information created by the object map creation unit 360.

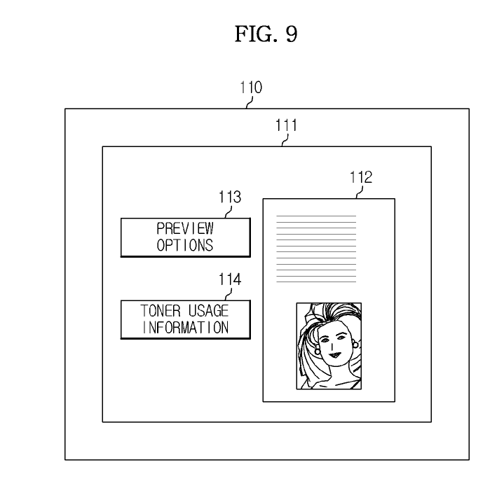

The dot count calculation unit 400 stores an RGB/dot count lookup table (LUT) and rapidly calculates a dot count using the stored RGB/dot count lookup table to measure toner consumption. As illustrated in FIG. 2C, the previewer 107 may output preview image data and dot count information. Alternatively, as illustrated in FIG. 9, the dot count information may be converted into text or graphics to be included in a preview screen displayed with the preview image data.

The RGB/dot count lookup table shows relations between RGB values and dot count values. Hereinafter, a method of preparing the RGB/dot count lookup table will be described.

Referring to FIG. 3, there is shown a process of calculating a dot count with respect to the data having passed through a process of converting RGB into CMYK that the printer 109 prints, a 1D LUT applying process, and a half toning process.

In the process of converting RGB into CMYK, a color space of the data is changed from RGB values used in the data before output into CMYK values used in the printer 109. Reference numeral 501 indicates the RGB image data, and reference numeral 502 indicates the conversion of RGB values to CMYK values.

In the 1D LUT applying process, the 1D LUT is applied to the data having the CMYK values based on the properties of each color to correct gamma.

In the half toning process, continuous gradation of the data is changed into binary gradation. Reference numeral 503 indicates the half-toning process of CMYK. Document data may have gradation values of 0 to 255. However, information necessary for the printer 109 to output data to paper is used to determine to which positions of the paper toner is applied, i.e., as on/off information. Therefore, the half toning process is performed. According to circumstances, 2-bit or 4-bit half toning may be applied.

In the dot count calculation process, as indicated by reference numeral 504, actual toner consumption is calculated using the data with respect to which the half toning has been completed. Reference numeral 505 of FIG. 3 indicates the print image data based on the CMYK dot counts 04.

Referring to FIG. 4, half toning is performed with respect to an image having a size of 4×4 pixels, with the result that a binary gradation value is applied to each pixel. Assuming that, when the half toning result is “0,” toner consumption is 0, and, when the half toning result is “1,” toner consumption is 224, the half toning result with respect to 8 pixels is “0,” and therefore, total toner consumption is 224×8, i.e., 1792.

RGB values of data having a predetermined size are changed to calculate a dot count, and dot count values corresponding to the respective RGB values are configured as the RGB/dot count lookup table. For example, RGB values of (0,0,0), (0,0,16), (0,0,32) . . . (0,16,0) . . . (255,255,255) may be configured with respect to data having a predetermine size (256×256), resulting in 17×17×17 samples, a dot count may be calculated with respect to each sample, and the results may be configured as a lookup table.

In consideration of object attributes, RGB/dot count lookup tables are separately prepared and stored for text, a graph, and a photo. For the text, among C, M, Y, and K toners, only the K toner is used for output. Since it is determined that a small amount of C, M, Y, and K toners is used when preparing the lookup table regardless of the object attributes, an error occurs. For the photo, the C, M, and Y toners are used much more than the K toner. Therefore, RGB/dot count lookup tables are separately configured for objects as described above to estimate accurate toner consumption.

Also, manufacturers may differently apply color conversion or half tone tables according to object attributes so as to improve document output quality. For this reason, RGB/dot count lookup tables are differently prepared based on object attributes.

Meanwhile, a K dot count corresponding to gray scales of 0 to 255 may be previously calculated to prepare an RGB/dot count lookup table corresponding to mono output. For example, RGB values of (0,0,0), (1,1,1), (2,2,2) . . . (255,255,255) may be configured to prepare 256 samples, a dot count may be calculated with respect to each sample, and the results may be configured as a lookup table.

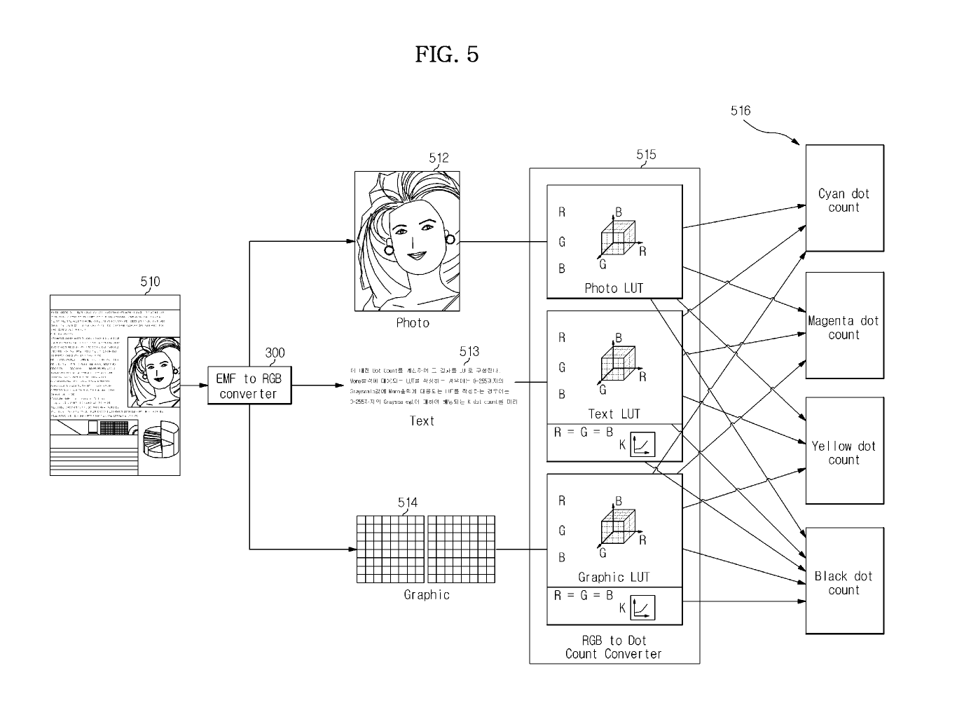

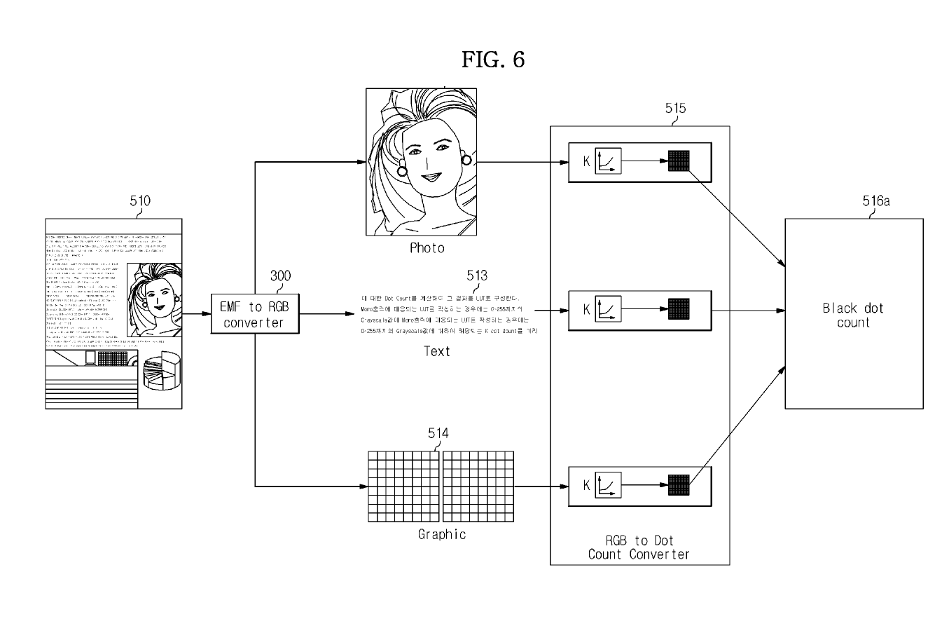

FIG. 5 is a view illustrating a dot count calculation process during color output of the detection apparatus of toner consumption according to an embodiment of the present general inventive concept, and FIG. 6 is a view illustrating a dot count calculation process during mono output of the detection apparatus of toner consumption according to an embodiment of the present general inventive concept.

Referring to FIG. 5, when the EMF creation unit 200 creates EMF data, the EMF/RGB converter 300 creates a BMP file from the EMF and classifies an object attribute of each pixel to form a map. In FIG. 5, the reference numeral 510 indicates the EMF data of the image, and reference numerals 512, 513, and 514 respectively represent the classification of each pixel into photo/picture pixels, text pixels, and graphic pixels, respectively.

The dot count calculation unit 400 calculates RGB values of each pixel and detects an object attribute of each pixel having the calculated RGB values.

The dot count calculation unit 400 divides the respective pixels into ones for text, a graph, and a photo based on the object attributes and applies values stored in the RGB/dot count lookup table to the RGB values of each pixel to calculate a dot count. Reference numeral 515 represents the RGB/dot count lookup table, and reference numeral 516 represents the respective dot counts of cyan, magenta, yellow, and black.

The dot count calculation unit 400 calculates dot counts of all pixels of the data file and sums the dot counts. The dot count calculation unit 400 multiplies the sum of the dot counts by toner consumption per dot to calculate total toner consumption.

Referring to FIG. 6, upon calculation of a dot count for mono output, a K dot count is calculated using an RGB/dot count lookup table, represented by reference numeral 515. Reference numeral 516a represents the black dot count.

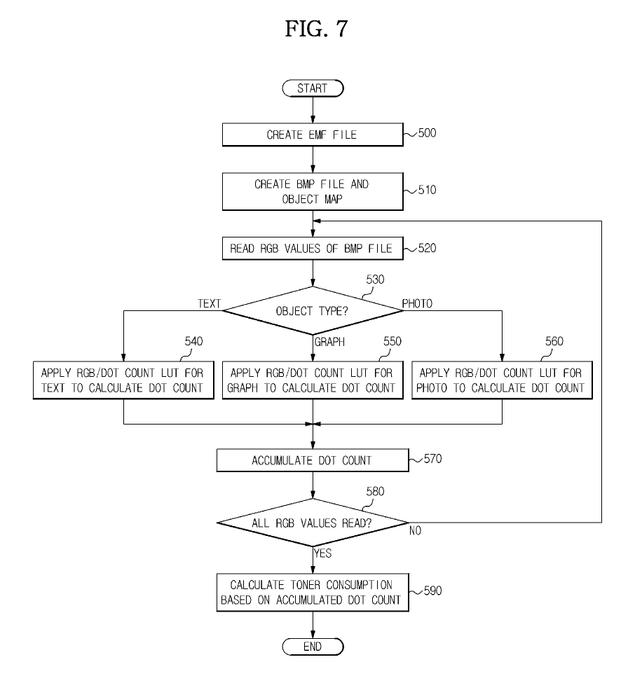

FIG. 7 is a flow chart illustrating a toner consumption measuring method of the detection apparatus of toner consumption according to the embodiment of the present general inventive concept.

In operation 500, the EMF creation unit 200 converts an original document into an EMF-format document based on spool data created according to a print command.

Subsequently, the preview data creation unit 330 converts the EMF into a BMP file of a preview data format. When the EMF is converted into the BMP file, a preview file may be displayed on the display 110. When the EMF is converted into the BMP file, RGB values of each pixel are recognized. The object map creation unit 360 records an object attribute of each pixel of the EMF to create a map in operation 510.

Subsequently, in operation 520, the dot count calculation unit 400 sequentially reads RGB values of each pixel of the BMP file. The dot count calculation unit 400 reads RGB values of a pixel for each control process.

Subsequently, in operations 530 to 560, the dot count calculation unit 400 reads an object attribute of the pixel, the RGB values of which have been read, and applies an RGB/dot count lookup table according to the attributes to calculate a dot count. That is, when the object attribute of the pixel the RGB values of which have been read is text, an RGB/dot count lookup table for the text is applied to calculate a dot count in operation 540. When the object attribute of the pixel is a graph, an RGB/dot count lookup table for the graph is applied to calculate a dot count in operation 550. When the object attribute of the pixel is a photo, an RGB/dot count lookup table for the graph is applied to calculate a dot count in operation 560.

Subsequently, in operation 570, the dot count calculation unit 400 accumulates the dot counts calculated at operations 540 to 560. For color printing, the dot count is separately accumulated for C, M, Y, and K toners. For black and white printing, the dot count is accumulated only for the K toner.

Subsequently, in operation 580, the dot count calculation unit 400 determines whether RGB values of all pixels of the BMP file have been read. The dot count calculation unit 400 already knows the number of pixels of the BMP file. If calculation has not been performed for the corresponding number of pixels, therefore, the dot count calculation unit 400 determines that RGB values of all pixels of the BMP file have not been read.

When it is determined at operation 580 that RGB values of all pixels of the BMP file have not been read, the procedure returns to operation 520, where RGB values of the remaining pixels are read, and operations 530 to 570 are performed to accumulate dot counts.

On the other hand, when it is determined at operation 580 that RGB values of all pixels of the BMP file have been read, toner consumption is calculated in operation 590 based on the accumulated dot counts. For color printing, the toner consumption is separately calculated for C, M, Y, and K toners.

According to one embodiment, MS Windows is used as an operating system (OS), and an EMF is used as a spool file for the previewer. However, another program, for example Mac OS, may be used as the OS. Also, a portable document format (PDF) file may be used as the spool file. That is, even when a spool file having a different format is used in a different OS, the same method as the above-described method may be used to consider object attributes of the spool file and apply RGB/dot count lookup tables based on object attributes to RGB values of the spool file, thereby calculating a dot count.

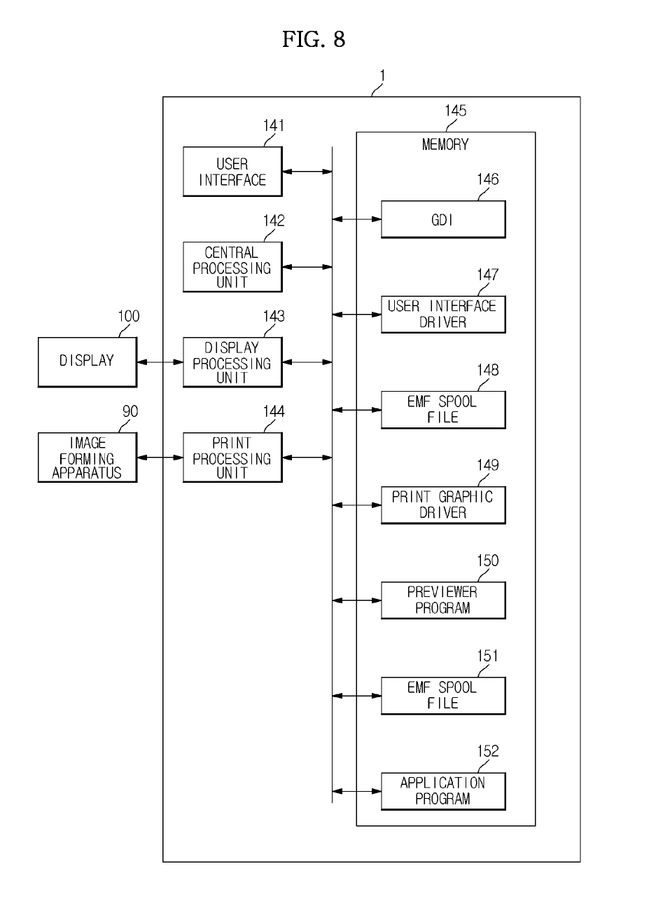

FIG. 8 illustrates an example of a printing control apparatus 1 according to an embodiment of the present general inventive concept. The printing control apparatus 1 may include a user interface 141, such as a keyboard, keypad, touch-pad, mouse, or other input to receive an input from a user to control a printing operation. A central processing unit 142 may control general operations of the printing control apparatus 1, such as detecting inputs and controlling outputs. The display processing unit 143 may include one or more processors, memory, and logic units to receive data and to convert the data to display data to be displayed on a display 100, such as a screen, monitor, or other display device. The print processing unit 144 may include one or more processors, memory, and logic devices to receive data and to convert the data to print data to be printed by an image forming apparatus 90 connected to the printing control apparatus 1. The central processing unit 142 may control operation of the display processing unit 143 and the print processing unit 144, such as determining which data is input to the respective processing units and to where the data is transmitted from the respective processing units.

Each of the processing units 142, 143, and 144 may be separate processing units, or they may be part of one processing unit. For example, the central processing unit 142 may control all of the functions of display processing and print data processing using predetermined programs stored in memory.

The printing control apparatus 1 may also include memory 145 to store programs, applications, and data. The memory 145 may include ROM, RAM, hard disks, or any other type of memory. Although various programs are illustrated in FIG. 8 as being stored in memory 145, some of the programs may be stored in ROM (e.g. the user interface driver 147) and some may be stored in RAM (e.g. the EMF spool files 148 and 151). The graphics device interface 146, user interface driver 147, print graphic driver 149, previewer program 150, and application program 152 may all be programs stored in memory to be accessed by the processing units 142, 143, and 144 to perform print functions, and may correspond to the GDI 20, user interface driver 30, print graphic driver 60, previewer 70, and application program 10 of FIG. 1. Similarly, the EMF spool files 148 and 151 may include data stored in memory and may correspond to the EMF spool files 40 and 80 of FIG. 1.

While the graphics device interface 146, user interface driver 147, print graphic driver 149, previewer program 150, and application program 152 are illustrated as being programs in FIG. 8, each may also correspond to physical circuitry, such as a processor, memory, and logic circuitry. For example, a previewer 70, as illustrated in FIG. 1 may include the print processor 50, memory, and supporting logic, and the print processor 50 may access code from the memory to generate a print preview. In such a case, the preview data creation unit 330 of FIG. 2A may include, for example, a processor and supporting logic to receive the EMF and to generate preview data. Similarly, the object map creation unit 360 of FIG. 2A may include a processor, such as a graphics processor, to receive the EMF and to generate an object map. The dot count calculation unit 400 may include a processor and one or more counters, registers, or data stored in memory to calculate the dot count information discussed above, and to store the accumulated dot count information to determine remaining toner levels. The above-described processors, logic units, and memory of the previewer 70 may include separate processors, one processor dedicated to the previewer 70, a processing unit 142, 243, or 144 illustrated in FIG. 8.

FIG. 9 illustrates a print preview screen 111 displayed on a display 110 according to an embodiment of the present general inventive concept. The print preview screen 111 may include a preview 112 of image data to be printed, preview options 113 to change colors, mono/color printing, page size, number of pages, dimensions of pages, order of pages, or any other print characteristics. The preview screen 111 may also include a toner usage information area 114 to display the toner usage information calculated by the dot count calculation unit 400, for example. In other words, the dot count information may be processed by a graphics controller to display the information as data to a user, and the user may change one or more preview options of the preview options window 113 to determine different estimated toner usage levels of a print operation.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, and optical data storage devices. The computer-readable recording medium can also be distributed over network coupled computer systems so that the computer-readable code is stored and executed in a distributed fashion. The computer-readable transmission medium can generate or transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As is apparent from the above description, information on toner consumption is provided to a user in consideration of object attributes of a preview document based on a document to be actually output.

Although a few embodiments of the present general inventive concept have been shown and described, it would be appreciated by those skilled in the art that changes may be made in these embodiments without departing from the principles and spirit of the general inventive concept, the scope of which is defined in the claims and their equivalents

What is claimed is:

1. A detection apparatus of toner consumption comprising:
an enhanced meta file (EMF) creation unit to convert an original file into an EMF so as to perform preview before printing an image of the original file;
a preview data creation unit to convert the EMF into preview data;
an object map creation unit to classify objects in the EMF to create an object map; and
a dot count calculation unit to calculate dot counts of pixels based on RGB values of the preview data and object attributes from the object map so as to detect toner consumption.

2. The detection apparatus according to claim 1, wherein the dot count calculation unit calculates the dot counts of the pixels using an RGB/dot count lookup table showing relations between the RGB values of the preview data and the dot counts.

3. The detection apparatus according to claim 2, wherein
the object attributes comprise a graph, a photo, and text, and
the RGB/dot count lookup table comprises a plurality of RGB/dot count lookup tables in which the dot counts correspond to the RGB values based on the object attributes.

4. The detection apparatus according to claim 3, wherein the dot count calculation unit calculates RGB values of the pixels of the preview data, detects object attributes of the pixels, the RGB values of which have been calculated based on the object map, and applies the RGB/dot count lookup tables prepared based on the object attributes of the pixels to the RGB values of the pixels to calculate dot counts of the pixels.

5. The detection apparatus according to claim 1, wherein the dot count calculation unit calculates dot counts of all pixels of the preview data and multiplies the calculated dot counts by toner consumption per dot to calculate total toner consumption.

6. The detection apparatus according to claim 1, wherein the object map creation unit classifies the objects as one selected from a group consisting of text, a photo, and a graph based on types of the items recorded in the EMF to create an object map.

7. A detection method of toner consumption comprising:
converting an original file into a spool file to perform preview before printing and storing the spool file;
converting the spool file into preview data;
classifying objects based on types of items recorded in the spool file to create an object map; and
calculating dot counts based on the preview data and information of the object map to detect toner consumption.

8. The detection method apparatus according to claim 7, wherein the spool file for preview comprises an enhanced meta file (EMF) or a portable document format (PDF) file.

9. The detection method apparatus according to claim 7, wherein converting the spool file into preview data comprises converting the spool file into a picture file which is displayed on a screen during preview.

10. The detection method apparatus according to claim 7, wherein classifying objects based on types of items recorded in the spool file to create an object map comprises classifying the objects as one selected from a group consisting of text, a photo, and a graph based on types of the items recorded in the spool file to create an object map.

11. The detection method apparatus according to claim 7, further comprising calculating dot counts of the pixels using an RGB/dot count lookup table showing relations between the RGB values of the preview data and the dot counts.

12. The detection method apparatus according to claim 11, wherein
each of the objects has an attribute of a graph, a photo, or text, and
the RGB/dot count lookup table comprises a plurality of RGB/dot count lookup tables in which the dot counts correspond to the RGB values based on the object attributes.

13. The detection method apparatus according to claim 12, wherein calculating dot counts based on the preview data and information of the object map comprises calculating RGB values of the pixels of the preview data, detecting object attributes of the pixels the RGB values of which have been calculated based on the object map, and applying the RGB/dot count lookup tables prepared based on the object attributes of the pixels to the RGB values of the pixels to calculate dot counts of the pixels.

14. The detection method apparatus according to claim 7, further comprising calculating dot counts of all pixels of the preview data and multiplying the calculated dot counts by toner consumption per dot to calculate total toner consumption.

15. A method of determining toner consumption, the method comprising:
classifying objects of an enhanced meta file (EMF) into a plurality of object types; and
applying different dot count data to each object type to generate dot count information of the EMF.

16. The method of claim 15, converting the EMF to RGB image data, and classifying the objects of the RGB image data into the plurality of object types.

17. The method of claim 15, wherein the plurality of object types includes at least text, graphics, and photos.

18. The method of claim 15, wherein applying different dot count data includes applying separate lookup tables to each respective type of object to generate separate dot counts for each type of object.

19. The method of claim 18, wherein the separate dot counts correspond to print colors of a printing device, and
the dot counts of each object corresponding to a respective color of the printing device are added together to generate total dot counts for each respective color of the printing device.

20. The method of claim 19, wherein generating separate dot counts for each type of object includes adding up a number of pixels corresponding to each type of object, and
multiplying the number of pixels corresponding to each type of object by a respective predetermined dot count value.

21. The method of claim 15, wherein classifying objects of the EMF includes detecting the object type corresponding to each pixel of the EMF.

22. The method of claim 15, further comprising:
generating a preview image based on the EMF.
